(19) United States
(12) Patent Application Publication
(10) Pub. No.: US 2010/0272249 A1
(43) Pub. Date: Oct. 28, 2010

(54) Spatial Presentation of Audio at a Telecommunications Terminal

(75) Inventors: Eric John Diethorn, Long Valley, NJ (US); Heinz Teutsch, Green Brook, NJ (US)

Correspondence Address: Avaya;DEMONT & BREYER, LLC, 100 COMMONS WAY, STE 250, HOLMDEL, NJ, 07733, US

(73) Assignee: AVAYA INC., Basking Ridge, NJ (US)

(21) Appl. No.: 12/427,823

(22) Filed: Apr. 22, 2009

(51) Int. Cl. H04M 3/42; H04R 5/00

(52) U.S. Cl. 379/202.01; 381/17

(57) ABSTRACT

The present invention utilizes pseudo-stereo for the communication of secondary information to the user of a telecommunications terminal, such as a speakerphone. In particular, the terminal utilizes a method for the presentation of secondary information to the user of the terminal in a teleconference call by adjusting the spatial properties of the monaural audio received at the user's terminal. An audio communication is modified so as to appear that the communicated audio is arriving from a particular direction in relation to the user's approximate position, wherein the direction that is assigned to the audio depends on one or more characteristics of the call participant who is originating the audio. Each characteristic of a call participant on a call can comprise, while not being limited to, the customer satisfaction of the call participant, the urgency of a need of the call participant, the group membership of the call participant, or the product ownership of the call participant.

### FIELD OF THE INVENTION

The present invention relates to telecommunications in general and, more particularly, to the spatial presentation of audio at a telecommunications terminal.

### BACKGROUND OF THE INVENTION

Humans can perceive sound spatially because of the ability of the human brain to process two audio channels simultaneously. Because the human ears are spaced some distance apart, each ear perceives the same sound wave as having a slightly different phase and amplitude. This difference in phase and amplitude is what allows the human brain to perceive depth and direction of sound.

Stereophonic sound, popularly known as stereo, takes advantage of the ability of the human brain to perceive two audio channels simultaneously. Stereophonic sound is reproduced by using two independent audio channels directed to two loudspeakers, such as in a headset, so as to achieve a natural impression of sound coming from different directions. In the prior art, for example, the sound arriving from a particular far-end party of a telephone call can be assigned based on the far-end party's geographic location relative to the location of the listener or in an order in which the call participants joined a teleconference call.

The transmission of two audio channels, however, typically requires double the amount of bandwidth that is needed to transmit single-channel audio. For this reason, monaural sound, also known as mono, is preferred in telecommunications applications, particularly where bandwidth is limited.

### SUMMARY OF THE INVENTION

Although monaural sound is relatively flat and less rich than stereo, it can be further processed to create the impression in the listener of depth and directionality. Pseudo-stereo techniques allow for the splitting and modification of a single audio channel into two separate channels in order to achieve depth and direction. The present invention utilizes pseudo-stereo for the communication of, among other things, secondary information to the user of a telecommunications terminal, such as a speakerphone. In particular, the illustrative embodiment of the present invention provides a method and terminal for the presentation of secondary information to the recipient participant, or “user,” of an audio communication, such as a teleconference call, by adjusting the spatial properties of the monaural audio received at the user's terminal. In accordance with the illustrative embodiment, an audio communication is modified so as to appear that the communicated audio is arriving from a particular direction in relation to the user's approximate position, wherein the direction that is assigned to the audio depends on one or more characteristics of the call participant who is originating the audio.

The telecommunications terminal of the illustrative embodiment receives signals that convey audio from one or more call participants, typically from one call participant at a time, as well as indications of the characteristics as they pertain to those call participants. The terminal processes the indications received, in order to determine the effects of multiple characteristics for a given call participant and to resolve conflicts in order to always assign the audio from each participant to a unique direction. The terminal then renders the audio from each participant through its two or more loudspeakers, in such a way to make it appear that each participant is situated in a different direction from the user's perspective.

A characteristic of a call participant on a call can comprise, while not being limited to, one or more of the customer satisfaction of the call participant, the urgency of a need of the call participant, the group membership of the call participant, the product ownership of the call participant, the credit score of the call participant, the age of the call participant, the time zone of the call participant, and so forth. Advantageously, by mapping the one or more characteristics of each call participant to a particular direction in relation to the user, the terminal of the illustrative embodiment is able to provide the user with valuable secondary information that, among other things, can help the user establish and maintain the context of each of the other call participants within each call.

In accordance with the illustrative embodiment, the terminal receives monaural audio from each far-end party on a telephone call. For example, the signals from one or more of the participants are first mixed into a composite signal at a teleconference bridge, which then transmits the composite signal to each terminal via a single channel. However, it will be clear to those skilled in the art, after reading this specification, how to make and use alternative embodiments of the present invention in which the terminal receives multi-channel audio from one or more of the far-end parties.

The illustrative embodiment of the present invention comprises: receiving at a first telecommunications terminal i) a first signal conveying monaural audio from a first call participant who is associated with a second telecommunications terminal and ii) a first indication of a first characteristic as it pertains to the first call participant, the first telecommunications terminal comprising a plurality of loudspeakers; and rendering, via the plurality of loudspeakers, the audio from the first call participant, which is distributed among the plurality of loudspeakers so as to appear to be coming from a first direction when rendered, the first direction being based on the value of the first indication.

### BRIEF DESCRIPTION OF THE DRAWINGS

FIG. 1 depicts a schematic diagram of the salient components of telecommunication terminal 100 in accordance with the illustrative embodiment.

FIG. 2 depicts a first example of telecommunications terminal 100 in a teleconferencing environment.

FIG. 3 depicts a second example of telecommunications terminal 100 in a teleconferencing environment.

FIG. 4 depicts a flow chart of the salient tasks associated with the illustrative embodiment.

FIG. 5 depicts a flow chart of the salient tasks associated with the assignment of direction to communications produced by a call participant in accordance with the illustrative embodiment.

### DETAILED DESCRIPTION

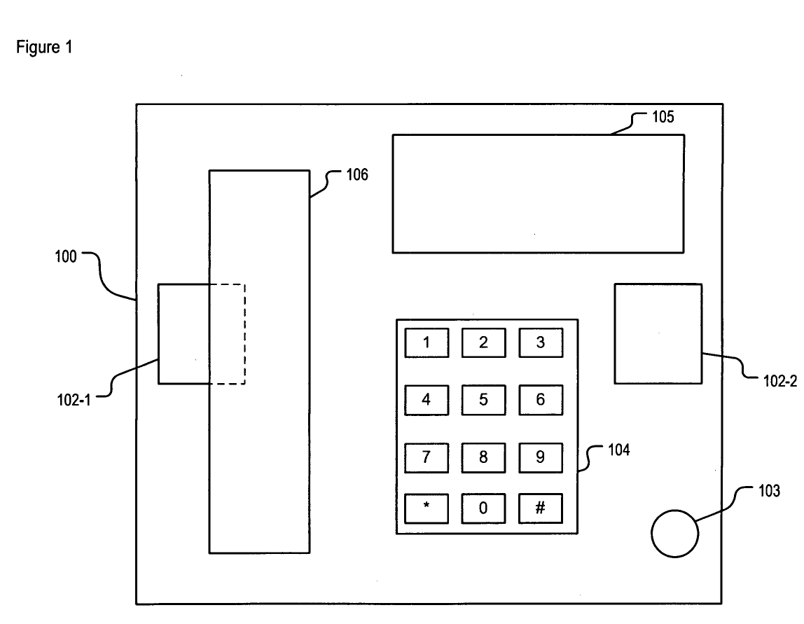

FIG. 1 depicts a schematic diagram of the salient components of telecommunication terminal 100 in accordance with the illustrative embodiment. Terminal 100 comprises loudspeakers 102-1 and 102-2, microphone 103, dial pad 104, display 105, and handset 106.

Terminal 100 enables its user to communicate with one or more far-end call participants (i.e., “parties”) in the course of a telephone call, in well-known fashion. Terminal 100 receives monaural audio from each far-end party participating on the telephone call. For example, the signals from one or more of the participants can be first mixed into a composite signal at a teleconference bridge or other data-processing system, which then transmits the composite signal to each terminal via a single channel. Additionally, in accordance with the illustrative embodiment, telecommunications terminal 100 comprises software and/or hardware for the conversion of monaural sound into pseudo-stereo as described later in this disclosure.

For pedagogical purposes, a “call participant” is considered to be a person who is present on a telephone call. However, as those who are skilled in the art will appreciate, a call participant can be a different audio source that is present on the telephone call, such as an intelligent robot agent producing an artificial voice, and so forth. Furthermore, different types of call participants (e.g., a person, a robot agent, etc.) can be present on the same telephone call.

Although terminal 100 receives monaural audio from each far-end party, it will be clear to those skilled in the art, after reading this specification, how to make and use alternative embodiments of the present invention in which the terminal receives multi-channel audio from one or more of the far-end parties.

Loudspeakers 102-1 and 102-2 are electroacoustical transducers that convert electrical signals to sound. Loudspeakers 102-1 and 102-2 are used to reproduce sounds produced by the other call parties. It will be clear to those skilled in the art how to make and use loudspeakers 102-1 and 102-2.

In accordance with the illustrative embodiment, terminal 100 comprises two loudspeakers, which the terminal uses to create a stereophonic effect for the audio being received from other call participants and rendered by the loudspeakers. It will be clear to those skilled in the art, after reading this specification, how to make and use alternative embodiments in which terminal 100 comprises more than two loudspeakers for creating a more precise and varied acoustical imaging effect.

Microphone 103 is an electroacoustical transducer. The microphone receives sounds from one or more near-end call participants and converts the sounds to electrical signals. In accordance with the illustrative embodiment, microphone 103 is an omnidirectional microphone. However, it will be clear to those skilled in the art, after reading this specification, how to make and use alternative embodiments in which other types of microphones are used, such as and without limitation subcardioid, cardioid, supercardoid, hypercardioid, bi-directional and shotgun, as well as combinations of two or more microphones arranged in microphone arrays.

Dial pad 104 is a telephone dial pad, display 105 is a telephone display, and handset 106 is a telephone handset, as are well-known in the art.

Terminal 100 processes monaural signals from one or more far-end parties into pseudo-stereo in accordance with the illustrative embodiment. It will be clear to those skilled in the art, however, after reading this disclosure, how to make and use alternative embodiments in which the processing of the monaural signal into pseudo-stereo is performed by a teleconference bridge or other data-processing system that mixes audio signals, a node located on the path between terminal 100 and the far-end party, a node that is capable of communicating with terminal 100, and so forth.

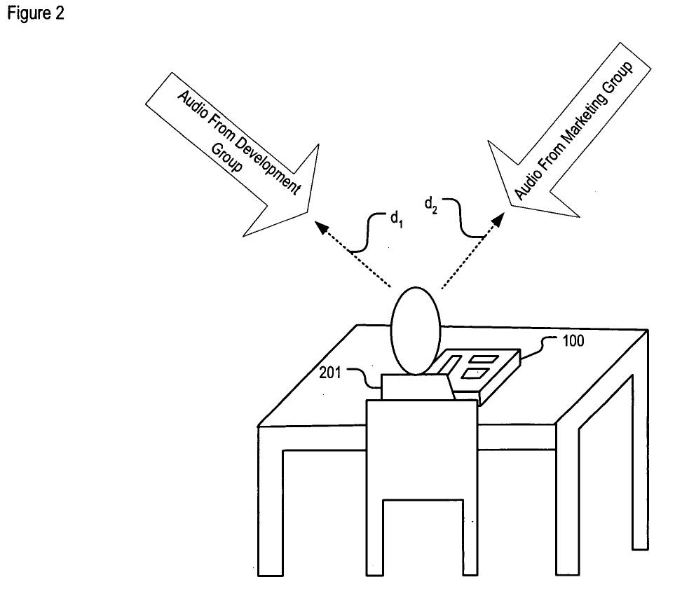

FIG. 2 depicts a diagram of telecommunications terminal 100 in a teleconferencing environment. As depicted, user 201 sitting at a desk is using terminal 100 situated on the desk to conduct a teleconference call with one or more far-end parties. User 201 is at least able to listen to the far-end parties through the loudspeakers of terminal 100. In accordance with the illustrative embodiment, each party in the call possess one or more characteristics, where at least one or more of the characteristics are determinative of the direction from which the sound appears to be coming for that party.

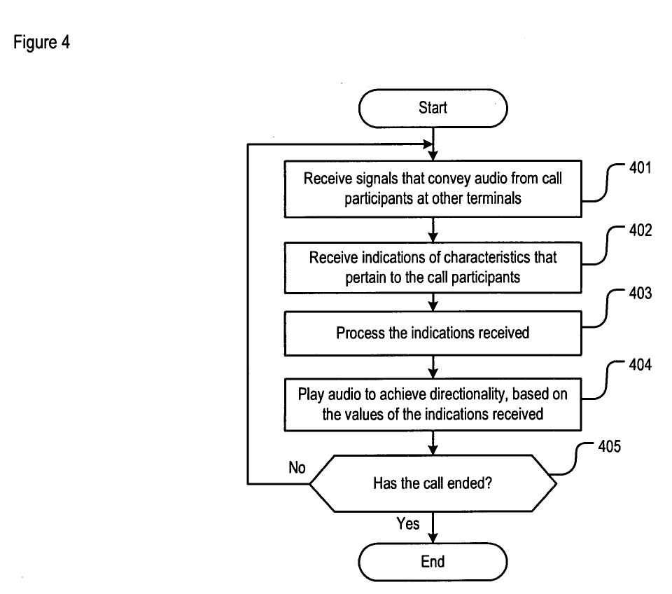

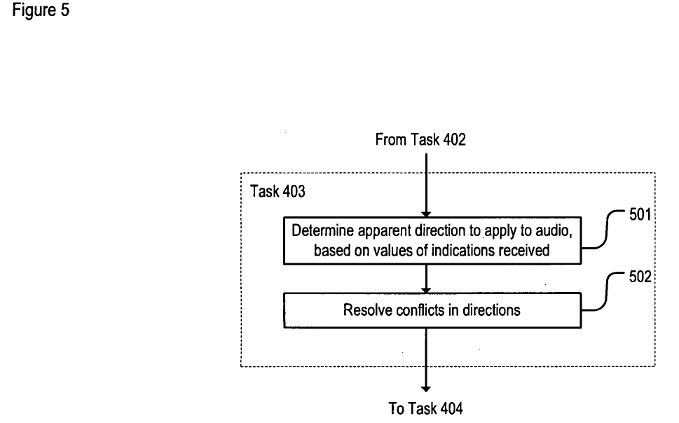

As a first example, the far-end parties that are involved in the teleconference call are members of various organizational groups, where the particular organizational group membership of a party is considered to be one example of a characteristic of that party. Some of the far-end parties might be members of a development group, and some of the other far-end parties might be members of a marketing group. In accordance with the illustrative embodiment, and as described below and with respect to FIGS. 4 and 5, the monaural audio being received from the members of the development group is modified so as to appear to be coming from direction d₁ (left). Similarly, audio coming from members of the marketing group is modified so as to appear to be coming from direction d₂ (right).

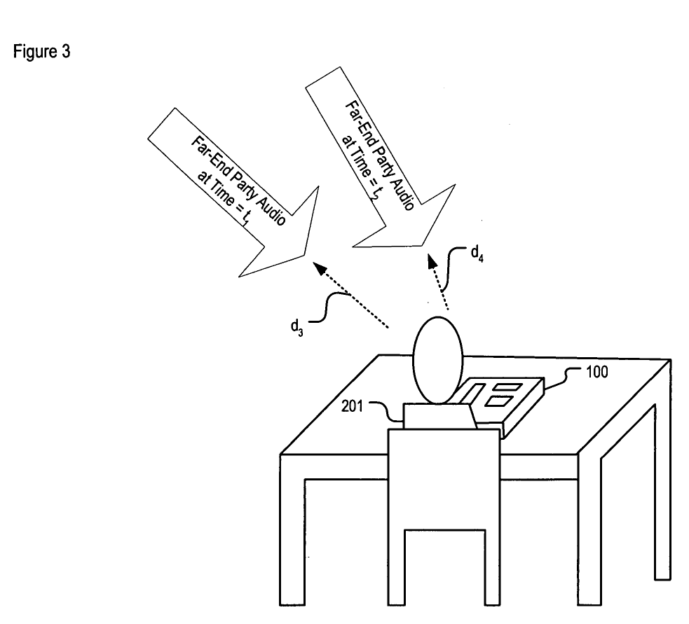

Referring now to FIG. 3, as a second example a characteristic of a far-end party can change during the phone call. In this example, the characteristic might be the urgency of a particular need of the party, where a lower urgency might correspond to a direction from alongside user 201 while a higher urgency might correspond to a direction in front of user 201. Initially, terminal 100 presents the apparent direction of audio being produced at time t₁ by the far-end party as appearing to be coming from direction d₃. During the call, a change in the characteristic (e.g., from lower urgency to higher urgency, etc.) is detected at time t₂, and as a result terminal 100 changes the apparent direction of audio produced by the far-end party from d₃ to d₄.

A characteristic of a call participant on a call can comprise, while not being limited to, one or more of the following:
i. customer satisfaction of the call participant,
ii. customer profile information,
iii. familial status,
iv. financial information,
v. the urgency of a need of the call participant (e.g., to obtain a predetermined service, to talk, etc.),
vi. group membership of the call participant,
vii. personal and/or professional associations of the call participant,
viii. product ownership of the call participant,
ix. employment information,
x. property ownership,
xi. credit score of the call participant
xii. age of the call participant,
xiii. time zone of the call participant,
xiv. a relationship of the call participant with respect to a user who is associated with the telecommunications terminal,
xv. number of calls previously initiated by the call participant, and
xvi. direction of the call participant in relation to the other telecommunications terminal.

It will be clear to those skilled in the art, after reading this disclosure, how to make and use alternative embodiments which are not responsive to changes in the characteristic of the call participant once the telephone call has commenced. Those skilled in the art will also appreciate that a number of alternative embodiments of the present invention are possible where the detection of the change of a characteristic of a call participant is performed by terminal 100, a teleconference bridge, a node located on the path between terminal 100 and the call participant, a node that is capable of communicating with terminal 100, and so forth.

FIG. 4 depicts a flow chart of the salient tasks associated with the illustrative embodiment. It will be clear to those skilled in the art, after reading this disclosure how to perform the tasks associated with FIG. 4 in a different order than presented or to perform the tasks simultaneously.

At task 401, terminal 100 receives signal s₁ from a first call participant and signal s₂ from a second call participant, possibly in addition to signals from other call participants as well. Although two far-end parties are featured for pedagogical purposes, it will be clear to those skilled in the art, after reading this specification, how to handle calls that involve a different number of far-end parties. Each of signals s₁ and s₂ conveys monaural audio, where the signals are produced in the course of a teleconference call between user 201, a first call participant, and a second call participant. For example, a teleconference bridge can mix the audio signals from the call participants, resulting in signal s₁ originated by the first call participant being transmitted at time t₁ to terminal 100 and signal s₂ originated by the second call participant being transmitted at time t₂ to terminal 100.

In accordance with the illustrative embodiment, the signals arrive at terminal 100 through the same transmission medium, but it will be clear to those skilled in the art how to devise alternative embodiments in which the signals arrive through different media. Furthermore, in accordance with the illustrative embodiment the signals carry audio only, but it will be clear to those skilled in the art how to make and use alternative embodiments of the present invention, in which signals s₁ and s₂ carry other information, in addition to audio, such as and without limitation video, caller identification, authentication information, call participant characteristic information, and so forth.

At task 402, terminal 100 receives indication i₁ being representative of the first call participant and indication i₂ being representative of the second call participant. Both indications i₁ and i₂ represent information of a pertinent characteristic of the first and second call participants respectively. In some embodiments, the characteristic is independent of the geographic location of the call participants. The characteristic of each of the call participant is then used in the illustrative embodiment as a basis for determining the apparent direction of any communications produced by the call participants respectively. As discussed with respect to FIG. 2, in accordance with the illustrative embodiment, the call-participant characteristic might be information regarding organizational membership (e.g., in a development group, in a marketing group, etc.). However, it will be clear to those skilled in the art, after reading this disclosure, how to make and use alternative embodiments in which the characteristic is any information about the call participant.

With respect to when the indications are retrieved, each indication of a call-participant characteristic is provided coincidentally with the corresponding audio signal. Accordingly, each indication is provided or retrieved multiple times (e.g., periodically, sporadically, etc.) during the phone call. In some alternative embodiments, as those who are skilled in the art will appreciate, the indications are provided or retrieved once for a telephone call, such as during the setup phase of the phone call.

With respect to how the indications are retrieved, an indication of a call-participant characteristic is transmitted by using a control channel, in accordance with the illustrative embodiment. However, it will be clear to those skilled in the art how to make and use alternative embodiments in which the indication of a call-party characteristic is provided to terminal 100, for example and without limitation, via the same channel carrying the audio signals, via a different audio channel, and so forth. Moreover, an indication can be set at the beginning of a call (e.g., via the Session Initiation Protocol, etc.) or continually updated by being encoded in a message header (e.g., a Real-time Transport Protocol header, etc.), where the header is possibly extended in order to accommodate the one or more indications transmitted.

With respect to the mechanism which originates the indications, the indication of a call participant characteristic is initialized and provided by each call participant personally, in accordance with the illustrative embodiment. However, it will be clear to those skilled in the art how to make and use alternative embodiments in which the call-party characteristic is obtained from a database or provided by another source (e.g., a teleconferencing bridge, etc.). Alternatively, it will be clear to those skilled in the art how to make and use other alternative embodiments, in which the characteristic for each call participant is obtained by using pattern recognition techniques to determine a characteristic of each of the participants in a phone call, such as and without limitation image recognition, audio recognition, facial expression recognition, and so forth.

At task 403, terminal 100 processes the received indications for the first and second call participants, and determines the apparent directions of the audio from the first and second call participants. Task 403 is described below with respect to FIG. 5.

At task 404, terminal 100 uses pseudo-stereo signal processing techniques to modify monaural audio produced by the call participants so as to appear that the audio produced by each call participant, as rendered by the two loudspeakers of terminal 100, arrive from the direction determined at task 403. It will be clear to those skilled how to perform task 404. For example, the monaural audio from the first call participant is distributed between the two loudspeakers so as to appear to be coming from a first direction when rendered.

The time at which a particular apparent direction is applied to the output audio at terminal 100 can be defined by information in the audio stream that is being received at terminal 100 from the network. For example, the relative positions of the indications of the call-participant characteristics in the received audio stream can serve to demarcate when a first direction is applied to the audio stream and when a second direction is subsequently applied. However, it will be clear to those skilled in the art how to make and use other alternative embodiments, in which the time at which a particular apparent direction is applied to the output audio can be determined by using pattern recognition techniques to ascertain when a first participant in a telephone call has stopped talking and when a second participant has started talking. Examples of such pattern recognition techniques are image recognition, audio recognition, facial expression recognition, and so forth.

At task 405, terminal 100 determines if the call has ended. If not, task execution proceeds back to task 401. Otherwise, task execution ends.

FIG. 5 depicts a flow chart of the salient tasks associated with the assignment of direction to communications produced by a call participant in accordance with the illustrative embodiment. It will be clear to those skilled in the art, after reading this disclosure how to perform the tasks associated with FIG. 5 in a different order than presented or to perform the tasks simultaneously.

At task 501, terminal 100 executes the algorithm for assigning the apparent direction of audio coming from a first call participant. The algorithm is a sequence of steps for assigning an apparent direction to monaural audio produced by the call participant and the algorithm is based on a characteristic of the call participant that is independent of location. As discussed with respect to FIG. 2, in accordance with the illustrative embodiment, the algorithm comprises the assigning of apparent direction d₁ to communications coming from, for example, members of the development group and direction d₂ to communications coming from, for example, members of the marketing group.

As those who are skilled in the art will appreciate, the consideration of multiple characteristics for each individual call participant can be based on predetermined rules (e.g., add 20 to credit score only if employed, etc.) or on other considerations. Those who are skilled in the art will further appreciate that the assigned direction for each characteristic or combination of characteristics can be based on a predetermined set of rules (e.g., present the marketing group audio from the left and development group audio from the right, etc.) or on other considerations.

At step 502, terminal 100 resolves conflicts in the apparent directions for each user. When the direction assignment algorithm yields the same result for two different users, the conflict is resolved by executing a disambiguation algorithm. In accordance with the illustrative embodiment, when the first participant's audio and the second participant's audio are assigned to the same apparent direction at task 501, the apparent direction for sound produced by the first user is shifted by a predetermined number of degrees of azimuth (e.g., ninety degrees, etc.) in relation to user 201's approximate sitting position. However, it will be clear to those skilled in the art, after reading this disclosure, how to make and use alternative embodiments in which a different disambiguation algorithm is employed. Although in accordance with the illustrative embodiment the disambiguation is performed after the assignment of apparent direction, it will be clear to those skilled in the art, after reading this disclosure, how to make and use alternative embodiments of the present invention in which disambiguation is performed before the execution of the direction assignment algorithm of task 501, when the call participant characteristics obtained for two call participants are substantially equivalent to each other. It will also be clear to those skilled in the art how to devise alternative embodiments which use multiple disambiguation algorithms.

It is to be understood that the disclosure teaches just one example of the illustrative embodiment and that many variations of the invention can easily be devised by those skilled in the art after reading this disclosure and that the scope of the present invention is to be determined by the following claims.

What is claimed is:

1. A method comprising:
receiving at a first telecommunications terminal i) a first signal conveying monaural audio from a first call participant who is associated with a second telecommunications terminal and ii) a first indication of a first characteristic as it pertains to the first call participant, the first telecommunications terminal comprising a plurality of loudspeakers; and
rendering, via the plurality of loudspeakers, the audio from the first call participant, which is distributed among the plurality of loudspeakers so as to appear to be coming from a first direction when rendered, the first direction being based on the value of the first indication.

2. The method of claim 1 wherein the audio is received as a part of a telephone call, and wherein the first indication is received during the same telephone call.

3. The method of claim 1 wherein the first characteristic of the first call participant comprises the direction of the first call participant in relation to the second telecommunications terminal.

4. The method of claim 1 wherein the first characteristic of the first call participant comprises group membership.

5. The method of claim 1 wherein the first characteristic of the first call participant comprises product ownership.

6. The method of claim 1 wherein the first characteristic of the first call participant comprises credit score.

7. The method of claim 1 wherein the first characteristic of the first call participant comprises a relationship of the first call participant with respect to a user who is associated with the first telecommunications terminal.

8. The method of claim 1 comprising:
receiving at the first telecommunications terminal ii) a second signal conveying monaural audio from a second call participant and ii) a second indication of the first characteristic as it pertains to the second call participant; and
rendering, at the first telecommunications terminal, the audio from the second call participant, which is distributed among the plurality of loudspeakers so as to appear to be coming from a second direction when rendered, the second direction being based on the value of the second indication.

9. The method of claim 1 comprising:
receiving, at the first telecommunications terminal, a second indication of a second characteristic as it pertains to the first call participant; and
rendering, at the first telecommunications terminal, the audio from the first call participant, which is distributed among the plurality of loudspeakers so as to appear to be coming from a second direction when rendered, the second direction being based on the values of the first indication and second indication.

10. A method comprising:
receiving at a telecommunications terminal i) a first signal conveying audio produced by a first source at time t₁ and ii) a first indication i₁ of a first characteristic as it pertains to the first source;
rendering, at the telecommunications terminal, the audio produced at time t₁ modified so as to appear to be coming from a first direction d₁, the first direction being based on i₁;
receiving at the telecommunications terminal i) a second signal conveying audio produced by a second source at time t₂ and ii) a second indication i₂ of the first characteristic as it pertains to the second source; and
rendering, at the telecommunications terminal, the audio produced at time t₂ modified so as to appear to be coming from a second direction d₂, the second direction being based on i₂;
wherein the audio produced at time t₁ and the audio produced at time t₂ are produced during the same telephone call; and
wherein i₁≠i₂, t₁≠t₂, and d₁≠d₂.

11. The method of claim 10 wherein the first indication i₁ is received during the same telephone call as the audio produced at time t₁.

12. The method of claim 10 wherein the audio produced by the first source at time t₁ is monaural.

13. A method comprising:
receiving at a telecommunications terminal i) a first signal conveying audio produced by a first source at time t₁ and ii) a first indication i₁ of a first characteristic as it pertains to the first source;
rendering, at the telecommunications terminal, the audio produced at time t₁ modified so as to appear to be coming from a first direction d₁, the first direction being based on i₁;
receiving at the telecommunications terminal i) a second signal conveying audio produced by the first source at time t₂ and ii) a second indication i₂ of the first characteristic as it pertains to the first source; and
rendering, at the telecommunications terminal, the audio produced at time t₂ modified so as to appear to be coming from a second direction d₂, the second direction being based on i₂;
wherein i₁≠i₂, t₁≠t₂, and d₁≠d₂.

14. The method of claim 13 wherein the audio produced at time t₁ and the audio produced at time t₂ are produced during the same telephone call.

15. The method of claim 13 comprising:
receiving at the telecommunications terminal i) a third signal conveying audio produced by a second source at time t₃ and ii) a third indication i₃ of the first characteristic as it pertains to the second source; and
rendering, at the telecommunications terminal, the audio produced at time t₃ modified so as to appear to be coming from a third direction d₃, the third direction being based on i₃;
wherein t₁≠t₃, and d₁≠d₃.

16. The method of claim 13 wherein the audio is received as a part of a telephone call, and wherein the first indication is received during the same telephone call.

17. A method comprising:
receiving at a telecommunications terminal: i) a first signal conveying audio from a first call participant, ii) a first indication i₁ of a first characteristic as it pertains to the first call participant, iii) a second signal conveying audio from a second call participant, and iv) a second indication i₂ of the first characteristic as it pertains to the second call participant; and
when i₁≠i₂, rendering at the telecommunications terminal i) the audio from the first call participant, modified so as to appear to be coming from a first direction d₁ that depends on i₁, and ii) audio from the second call participant, modified so as to appear to be coming from a second direction d₂ that depends on i₂;
wherein d₁≠d₂.

18. The method of claim 17 further comprising:
when i₁=i₂, rendering at the telecommunications terminal i) the audio from the first call participant, modified so as to appear to be coming from a third direction d₃, and ii) the audio from the second call participant, modified so as to appear to be coming from a fourth direction d₄;
wherein d₃≠d₄.

19. The method of claim 17 wherein the first characteristic of the first call participant comprises group membership.

20. The method of claim 17 wherein the first characteristic of the first call participant comprises product ownership.

21. The method of claim 17 wherein the first characteristic of the first call participant comprises a relationship of the first call participant with respect to a user who is associated with the telecommunications terminal.
